(19) United States
(12) Patent Application Publication
(10) Pub. No.: US 2004/0060373 A1
(43) Pub. Date: Apr. 1, 2004

(54) Fluid receptacle assembly

(76) Inventor: James Frederick Pharaoh, Hamilton (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/405,350

(22) Filed: Apr. 1, 2003

(30) Foreign Application Priority Data
Sep. 27, 2002 (NZ) 521678

(51) Int. Cl. G01N 1/10; F16K 51/00; A01J 9/00; A01J 5/01

(52) U.S. Cl. 73/863.02; 73/863.86; 137/800; 119/14.46

(57) ABSTRACT

A fluid receptacle for holding a fluid including a fluid outlet for allowing the fluid to drain from the fluid receptacle and a closure mechanism associated with the fluid outlet. The closure mechanism is configured to shut off the fluid outlet automatically after the fluid receptacle has been drained of the fluid. Also a method of operating a fluid receptacle for holding a fluid including filling at least a part of a fluid receptacle with fluid, operating an actuator of a closure mechanism to initiate draining of fluid from the fluid receptacle through a fluid outlet, and using the closure mechanism to automatically reseal the fluid outlet once the fluid receptacle has been drained of the fluid.

### TECHNICAL FIELD

This invention relates to an improved fluid receptacle assembly.

In particular, this invention relates to a fluid receptacle for use in animal husbandry where the milking of an animal is required.

Reference throughout the specification shall now be made to use of the present invention in relation to the milking of animals, and in particular cows within a milking shed.

However this should not necessarily be seen to be a limitation on the present invention in any way as it may be used for other fluids and/or animals and in other locations whenever it is deemed to be suitable.

### BACKGROUND ART

The use of fluid receptacles within the dairy industry is well known, particularly for the measuring of the amount of milk collected from each animal.

When milk was manually extracted from animals accurate measuring of the volume delivered was at best difficult and often impossible.

One way would be to use a dipstick or sightglass on a storage tank and another method would be to use jugs of known volume to measure out the amount of milk collected.

Not only were these methods very inconvenient and inaccurate but they were also time consuming to do.

A huge improvement over this was brought about by the introduction of the electromechanical milking parlour that utilises a pulsed vacuum source to draw milk from the udder via a teat cluster.

These systems are generally fitted with a milk metering assembly which draws off a known percentage of the milk being collected and places it into a measuring vessel so that the total volume of milk being collected from an animal can be calculated on a graduated chart on the measuring vessel.

One such system is disclosed in New Zealand Patent No. 207822 which uses a baffled dome to separate a known percentage of the collected milk for entry into a measuring chamber.

If a sub-sample is required then a valve is opened manually to allow milk to flow into a vial.

The remaining milk within the measuring vessel is then released through a further manually operated valve into the main storage tank.

Another system is disclosed in New Zealand Patent No. 207284, this system uses a borehole in a piston to separate a known percentage into the measuring flask.

A sub-sample from the flask can, if desired, be drawn off for testing with the remaining milk being emptied into the main tank by rotating the measuring flask until the correct inlets and outlets are aligned.

Whilst both of these representative examples perform the required task they do have some significant drawbacks.

A major drawback with the current systems is that they require the operator to open and close at least one valve (sometimes more) between the milking of two animals in order to ensure the correct measuring of the milk produced by each animal is achieved.

This is not only time-consuming in an industry where speed is always very important but it also requires the operator to be constantly “on the ball” as it is easy to make errors, especially when in a hurry.

Another drawback is that the rotating-style valves that are used will wear due to their very frequent operation and can cause milk to leak out (which is very messy and if excessive will cause the total milk volume calculation to be inaccurate) but could also allow foreign matter to enter and contaminate the collected milk.

Due to the environment in which equipment is installed any foreign matter would likely contain germs and/or any other desirables. Therefore it would be highly beneficial to have a system which could overcome some of these problems and preferably be able to take less operator time, reduce valve wear due to excessive rotations and minimise the chances of any leaks in or out of the system and that could also provide a sub-sample for testing if required.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a fluid receptacle for holding a fluid, including

a fluid outlet for allowing the fluid to drain from a fluid receptacle, and

a closure mechanism associated with the fluid outlet

characterised in that

the closure mechanism is configured to shut off the fluid outlet automatically after the fluid receptacle has been drained of the fluid.

It should be appreciated that throughout the present specification the term “fluid receptacle” should be understood to mean a container configured to be able to hold a volume of fluid and which has a fluid inlet and a fluid outlet. In preferred embodiments the fluid receptacle is a milk meter. This however should not be seen as limiting.

It should also be appreciated that throughout the present specification the term “fluid” should be understood to mean a substance capable of flowing and that will yield to the slightest pressure. This may be particulate material, gas or liquid.

Reference throughout the present specification shall now be made to the fluid as being milk.

It should be appreciated however that this should not be seen to be a limitation on the present invention in any way as the present invention is equally capable of operating with fluids other than milk.

Also throughout the present specification the term “closure mechanism” should be understood to mean a scaling apparatus for controlling the flow of the fluid out of the receptacle via the fluid outlet.

Throughout the present specification the term “fluid outlet” should be understood to mean a sealable aperture for allowing the fluid to exit the fluid receptacle.

In preferred embodiments of the present invention the draining of the fluid from a receptacle is initiated by pressing an actuator.

In preferred embodiments of the present invention the actuator is a button, however this should not be seen to be a limitation on the present invention as in other embodiments the actuator can be any other form, or device, capable of initiating the draining of the fluid receptacle. Examples of this could be a pull toggle, a lever, etc.

In preferred embodiments of the present invention the operation of the actuator will cause a low pressure zone to form above a seal that is connected to the closure mechanism.

In most preferred embodiments of the present invention the seal used will be a gland seal. However once again this should not be seen to be a limitation on the present invention in any way as any other type of appropriate seal may be used.

This low pressure zone causes the seal to distort to the point where it causes the closure mechanism to be pulled away from the valve seat thereby allowing the contents of the fluid receptacle to flow through the fluid outlet and hence drain the fluid receptacle.

In preferred embodiments of the present invention the fluid drained from the fluid receptacle passes through a sampling assembly that is configured in such a matter that a sample of the fluid is automatically collected during the draining operation.

In preferred embodiments of the present invention the automatic collection of the fluid during the draining procedure is achieved by using an in-line sump sampler connected to the pipework from the fluid outlet.

This type of sampler has a sump that is physically lower than the pipe to which it is connected so that fluid from within the pipe will fall and fill the sump before continuing into the pipework that exits the sump sampler. This ensures that the sump will always fill before any fluid passes past the sampler.

It should be noted however that this should not be seen to be a limitation on the present invention in any way as the present invention is equally suitable for use with other types of sampler.

It should be noted that the usual sample size taken from milking systems is approximately 18-25 ml. Therefore it is anticipated that the removable vial that forms the sump within the automatic sampler will generally be of a volume within this region however this should not be seen to be a limitation in any way as vials of different sizes can be used to acquire different sample sizes.

This type of sampling has several advantages one being that the samples are always of the same volume when the same volume vial is used.

In preferred embodiments of the present invention initiation of the actuator causes a volume of gas to enter the fluid receptacle through an orifice (such as a pipe) in such a manner that the fluid is agitated just prior to draining from the fluid receptacle to ensure that the fluid is in the form of a homogenised mixture when drained from the fluid receptacle.

In preferred embodiments of the present invention the gas used to agitate the fluid within the fluid receptacle is supplied by a reservoir, the volume of the reservoir determines the agitation time of the fluid before the fluid outlet is opened.

It should be appreciated that if a longer agitation time is required in particular circumstances then that provided automatically by the reservoir then the agitation time can be extended by the manual depression and holding down of the actuator wherein the release of the actuator will cause the present invention to revert to its automatic mode of operation.

It should also be appreciated that in embodiments of the present invention where a longer agitation time is required as a matter of course then a reservoir with a suitable capacity can be fitted in order to provide an acceptable level of agitation.

It should be appreciated that in preferred embodiments of the present invention the gas that enters the fluid receptacle due to the initiation of the activator is air at atmospheric pressure.

This should not however be seen to be a limitation on the present invention in any way as other gasses and/or other pressures may be used to agitate the fluid and in assisting the draining process.

From the foregoing description it is clear that the current invention has a number of significant advantages over the current fluid measuring systems available.

The most significant advantage is that the draining and resetting of the measuring equipment is achieved by a single operation by the operator of the equipment.

Another significant advantage of the present invention is that due to its using the same vacuum source and output to milk-tank pipework as in the conventional systems it can be easily retrofitted to existing systems as a direct replacement for the existing milk meter. The only requirement is for the replacement of the original sampler lid and tap assembly in order to convert an existing milk meter to one that utilises the advantages of the present invention.

Another advantage, particularly over the prior art is that this sampling is automatic whereas with the prior art they are generally manual systems where the sample must be weighed, agitated, decanted and then tested. This is not only complex but it is also time consuming.

A further advantage of the present invention over the prior art is that due to the configuration of the present invention the milk deposited within the fluid receptacle is far less frothy than that deposited in the fluid receptacles of the prior art. This has the advantage that the volume of milk contained within the fluid receptacle can be measured far more accurately against an appropriate measurement system such as an integral measuring scale fixed to the fluid receptacle.

Another advantage of the present invention is that due to the configuration of the sampling system the sampling vial will at least partially self purge between samples, i.e. if for any reason a sample vial is not taken out after the fluid receptacle has been drained then the vial contents will be purged and replaced by milk from the next animal in the next draining cycles of the equipment.

Another advantage is due to the automatic nature of the control of the valve assembly within the fluid receptacle the problems associated with the use of a rotational valve have been eliminated. This not only improves the durability of the equipment but also ensures a higher level of system integrity with a much lower chance of any introduction of foreign material into the milk.

A further advantage is that due to the system only requiring a single action by the operator the overall time for milking each animal can be reduced as once the draining has been activated the operator can then focus on preparing the next animal for milking within that stall.

Another advantage is that a sub-sample is automatically collected each time the fluid receptacle is drained in embodiments where a sub-sample is required.

### BRIEF DESCRIPTION OF DRAWINGS

Further aspects of the present invention will become apparent from the following description which is given by way of example only and with reference to the accompanying drawings in which:

FIG. 1 is a diagrammatic representation of one preferred embodiment of the present invention shown prior to the draining being initiated; and

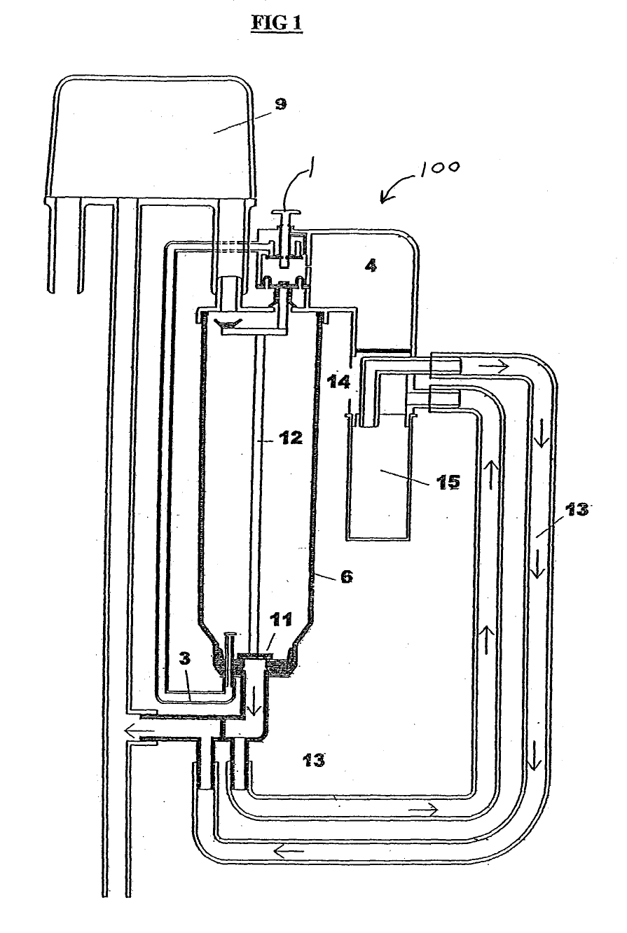

FIG. 2 is a diagrammatic representation of one preferred embodiment of the present invention shown during draining of the fluid receptacle, and

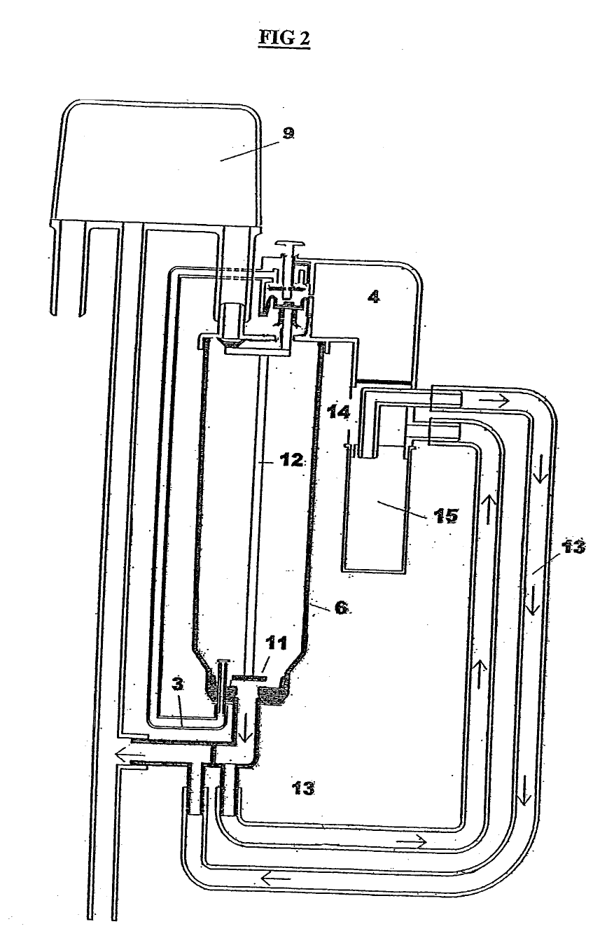

FIG. 3 is a diagrammatical representation of a close up view of the activation assembly.

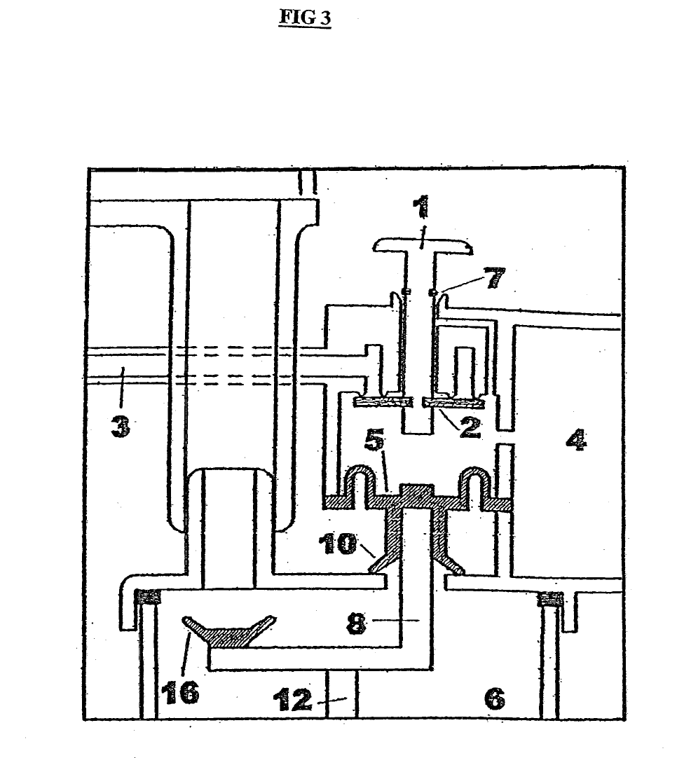

### BEST MODES FOR CARRYING OUT THE INVENTION

With reference to the figures there is illustrated a milk meter generally indicated by arrow (100).

The milk meter (100) consists of a standard metering head (9) which delivers a known percentage of the milk collected from an animal into fluid receptacle (6).

Once collection of milk from an animal has been completed then the volume of milk collected can be determined from the volume of milk within the fluid receptacle.

A small sub-sample of the milk collected is often desired in order to check certain parameters within the milk from a herd or from particular animals within a herd.

The fluid outlet of the fluid receptacle (6) is blocked by seal 11 at all times apart from during the draining cycle.

Full delivery of the milk from an animal can take some minutes and therefore by the time that delivery has been completed the contents of the fluid receptacle (6) can have stratified into different layers and therefore if a true representative sample is desired the contents of the fluid receptacle (6) will need to be agitated prior to a sample being taken.

The draining sequence will be now described in detail with reference to the diagrams.

When depressed, the actuator button (1) breaks the vacuum seal (2) that is normally present at the end of the conduit (3) that is connected from the base of the fluid receptacle (6) to the reservoir (4) that contains atmospheric air.

Fluid receptacle (6) is connected to a vacuum source within the metering heard (9) and the air is therefore drawn from the reservoir (4) into the fluid receptacle (6) until the pressure in the reservoir (4) drops sufficiently to lift a diaphragm (5) that is fitted in part of reservoir (4).

The capacity of the reservoir (4) determines the time taken for the pressure to drop sufficiently to lift the diaphragm (5) and in preferred embodiments this will occur between 0 and a few seconds after the vacuum seal (2) is breached.

The time delay allows for agitation of the fluid within the fluid receptacle (6) due to air passing into the fluid receptacle (6) via conduit (3) as described earlier.

Diaphragm (5) is located beneath the actuator (1) so that when diaphragm (5) is lifted fully it raises and resets the actuator button (1) into its non depressed position.

By resetting actuator button (1), vacuum seal (2) is restored at the end of conduit (3) and seal (7) is broken which will allow atmospheric air back into reservoir (4).

Diaphragm (5) is attached to a valve stem (8) which is connected to valve assembly (12) that is located within the fluid receptacle (6).

When diaphragm (5) is in its raised position it causes valve stem (8) to raise the valve assembly (12) to a position where seal (16) closes the vacuum source from within the metering head (9). This action also breaks seal (10) from the top of the fluid receptacle (6) which will allow atmospheric air to enter the fluid receptacle (6) around valve stem (8).

The raising of valve assembly (12) will also break seal (11) at the base of fluid receptacle (6) and this will therefore allow fluid to drain from the fluid receptacle (6) under the influence of gravity and the system vacuum, the direction of which is shown by the inline arrows within the bypass conduits (13).

Once all the fluid has been drained from the fluid receptacle (6) and the bypass conduits (13) the system vacuum will equalise inside the fluid receptacle (6) and reservoir (4), thus allowing the valve assembly (12) to drop back into its initial position which will close seals (10) and (11) and open seal (16).

A sample of the homogenised fluid from within the fluid receptacle (6) is automatically collected in vial (15) which is connected to the sampling head (14).

Both the sampling head (14) and the vial (15) are constantly exposed to the system vacuum.

When valve assembly (12) is raised and seal (11) is broken fluid will flow through the bypass conduits (13) into the vial (15). Once vial (15) is filled the excess fluid will pass through sampling head (14) along the second bypass conduit (13) over the top of the fluid collected in the vial (15).

The sample vial (15) can be removed once the fluid has been fully drained from the fluid receptacle (6) and a new vial (15) put in its place to collect a sample from the next draining of the fluid receptacle (6).

Therefore, not only is the draining of the fluid receptacle (6) and the resetting of the fluid receptacle assembly (100) automatic once actuator (1) has been depressed, but a fluid sample is also taken automatically.

Aspects of the present invention have been described by way of example only and it should be appreciated that modifications and additions may be made thereto without departing from the scope of the appended claims.

What we claim is:

1. A fluid receptacle for holding a fluid, comprising
a fluid outlet for allowing the fluid to drain from the fluid receptacle, and
a closure mechanism associated with the fluid outlet
wherein the closure mechanism is configured to shut off the fluid outlet automatically after the fluid receptacle has been drained of the fluid.

2. A fluid receptacle as claimed in claim 1 wherein the fluid receptacle is a milk meter.

3. A fluid receptacle as claimed in claim 1 which is configured so that the draining of the fluid from the receptacle is initiated by operating an actuator.

4. A fluid receptacle as claimed in claim 3 wherein the actuator is a button.

5. A fluid receptacle as claimed in any previous claim wherein the fluid outlet is connected to a sampling assembly.

6. A fluid receptacle as claimed in 5 wherein the sampling assembly is configured in such a manner that a sample of the fluid is automatically collected during the draining operation.

7. A fluid receptacle as claimed in claim 5 wherein the sampling assembly is configured to at least partially self-purge between samples.

8. A fluid receptacle as claimed in claim 1 wherein the actuator is configured in such a manner that when it is operated it causes a volume of gas to enter the fluid receptacle through an appropriate orifice in such a manner that the fluid within the fluid receptacle is agitated just prior to draining from the fluid receptacle.

9. A fluid receptacle as claimed in claim 8 wherein the continued manual depression of the actuator will cause the agitation of the fluid within the fluid receptacle to be continued until a period after the actuator is released.

10. A fluid receptacle as claimed in claim 3 wherein the fluid receptacle is configured so that the draining of the fluid receptacle is achieved by a single operation of the actuator by the operator of the fluid receptacle.

11. A fluid receptacle as claimed in claim 3 wherein the actuator is configured so that when it is operated it will cause a low pressure zone to form above a seal that is connected to the closure mechanism.

12. A fluid receptacle as claimed in claim 11 wherein the seal is a gland seal.

13. A fluid receptacle as claimed in claim 11 wherein the seal is configured so that the low pressure zone will distort the seal and cause the closure mechanism to open the fluid outlet.

14. A method of operating a fluid receptacle for holding a fluid, as disclosed in any previous claims comprising the steps of
a) filling at least a part of the fluid receptacle with fluid, and
b) operating the actuator of the closure mechanism to initiate the draining of fluid from the fluid receptacle through the fluid outlet, and
c) using the closure mechanism to automatically reseal the fluid outlet once the fluid receptacle has been drained of the fluid.
